(19) United States
(12) Patent Application Publication
(10) Pub. No.: US 2015/0083456 A1
(43) Pub. Date: Mar. 26, 2015

(54) CONDUCTIVE, VIBRATION DAMPENING ISOLATOR

(71) Applicant: 3M INNOVATIVE PROPERTIES COMPANY, St. Paul, MN (US)

(72) Inventors: Tony Y. Chen, Indianapolis, IN (US); Song Lu, Zionsville, IN (US); Mohiuddin Ahmed, Austin, TX (US)

(21) Appl. No.: 14/372,871

(22) PCT Filed: Jan. 15, 2013
(86) PCT No.: PCT/US2013/021542

§ 371 Date: Jul. 17, 2014

Related U.S. Application Data
(60) Provisional application No. 61/592,335, filed on Jan. 30, 2012.

(51) Int. Cl. H02G 15/007

(52) U.S. Cl. CPC H02G 15/007
USPC 174/73.1

(57) ABSTRACT

The present invention is a conductive isolator including a damping structure, a conductive bridge component positioned within the damping structure, axial contact points between the damping structure and the conductive bridge component and radial contact points between the damping structure and the conductive bridge component.

### CROSS REFERENCE TO RELATED APPLICATIONS

This application claims the benefit of U.S. Provisional Application No. 61/592,335, filed Jan. 30, 2012, the disclosure of which is incorporated by reference herein in its entirety.

### FIELD OF THE INVENTION

The present invention is related generally to vibration damping isolators. In particular, the present invention is a conductive, vibration damping isolator.

### BACKGROUND

Conductive isolation of a component can provide many benefits to system performance. However, if there is a need for conductivity, allowing for an electrical connection must be worked into the design as the connection is purposely kept separated.

Currently, shock and vibration issues are commonly resolved using isolators that reduce vibration and noise. For applications that require conductivity, such as grounding or electromagnetic interference (EMI), a separate “metal clip” can be attached to certain components to complete the electrical connection. While this method can be effective in establishing an electrical connection, the metal clip can reduce the performance of the isolator by introducing a path of transmission for vibration. In addition, modifications must be made to the design to only serve one purpose, bridging an electrical connection.

### SUMMARY

In one embodiment, the present invention is a conductive isolator including a damping structure, a conductive bridge component positioned within the damping structure, axial contact points between the damping structure and the conductive bridge component and radial contact points between the damping structure and the conductive bridge component.

In another embodiment, the present invention is an apparatus including a conductive isolator and an assembly housing the conductive isolator. The conductive isolator includes a damping structure, a conductive bridge component positioned within the damping structure, axial contact points between the damping structure and the conductive bridge component and radial contact points between the damping structure and the conductive bridge component. The assembly includes an insert plate and a screw adapted to engage a mounting hole in the insert plate.

In yet another embodiment, the present invention is a method of providing electrical connection through an isolator. The method includes providing an isolator having a conductive bridge component housed within a non-conductive damping structure and facilitating radial and axial contact points between the conductive bridge component and non-conductive damping structure.

### BRIEF DESCRIPTION OF THE DRAWINGS

FIG. 1a is a perspective view of a conductive isolator of the present invention.

FIG. 1b is a top view of the conductive isolator of the present invention.

FIG. 2 is a cross-sectional view of the conductive isolator of the present invention in a chassis assembly.

FIG. 3a is a perspective view of a screw of the chassis assembly of the present invention.

FIG. 3b is a cross-sectional of the screw of the chassis assembly of the present invention.

FIG. 3c is a top view of the screw of the chassis assembly of the present invention.

FIG. 4a is a cross-sectional view of the conductive isolator of the present invention in the chassis assembly through lines A-A shown in FIG. 1b.

FIG. 4b is an enlarged cross-sectional view of a conductive bridge component of the conductive isolator of the present invention.

FIG. 4c is a perspective view of the conductive bridge component of the conductive isolator of the present invention.

### DETAILED DESCRIPTION

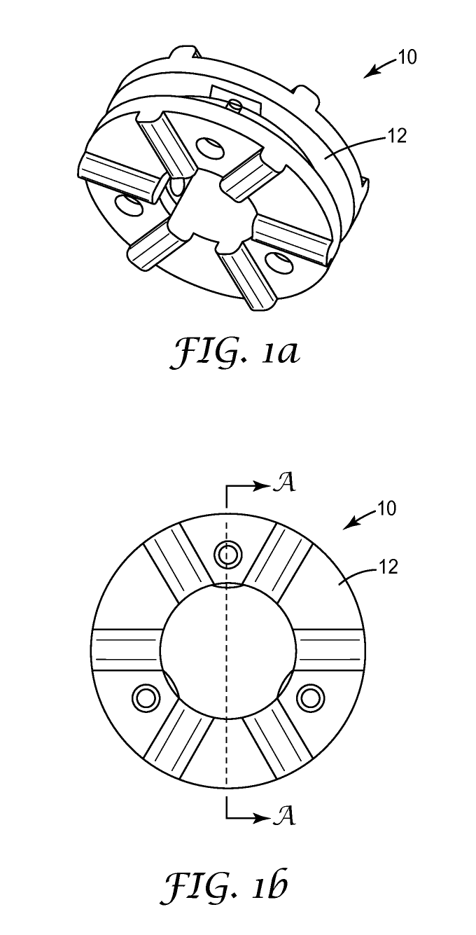

FIGS. 1a and 1b show a perspective view and a top view, respectively, of a conductive isolator 10 of the present invention. The conductive isolator 10 includes a non-conductive damping structure 12 with molded-in conductive components that can complete an electrical connection. The conductive components are captured within the damping structure 12 and are soft enough that they do not significantly impact the overall damping performance of the conductive isolator 10. By incorporating the conductive components into the damping structure 12, an electrical connection is bridged while still allowing the highly damped isolator to function as intended. The conductive isolator 10 eliminates separate grounding components, allowing for damping performance and electrical conductivity in one simple unit. In addition, the conductive isolator 10 has a fully adjustable height, an inner diameter, an outer diameter, a groove diameter, and rib geometry. The conductive isolator 10 is also manufacturable in any injection moldable material.

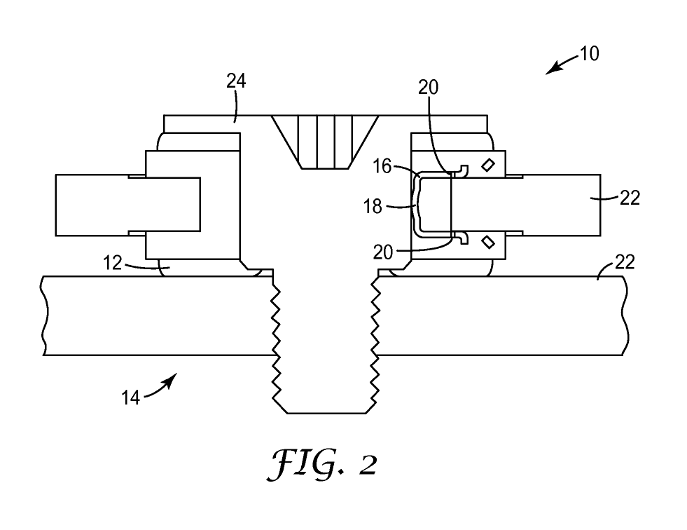

FIG. 2 shows a cross-sectional view of the conductive isolator 10 positioned in an assembly 14. As can be seen in FIG. 2, the conductive isolator 10 includes the damping structure 12, a conductive bridge component 16, radial contact points 18 and axial contact points 20. The assembly 14 includes an insert plate 22 with a screw, post, dowel or pin 24 positioned through the insert plate 22. The insert plate 22 may include, for example, sheet metal or a printed circuit board. In some embodiments, the insert plate 22 is separate from the screw 24. In other embodiments, the insert plate 22 and associated screw 24 are integral. In one embodiment, the assembly 14 is a chassis assembly.

The radial contact points 18 are specifically designed to protrude out of flush side walls of the assembly 14 in order to ensure a connection with the screw 24 during every installation orientation, whether it is horizontal or vertical. In one embodiment, the radial contact points 18 protrude out of the flush side wall of the assembly 14 by about 0.1 mm nominally, not exceeding about 0.2 mm with tolerance.

A flush contact point may not be enough to ensure a radial connection during every installation. The pre-compression of the damping structure from the screw will cause the material to bulge inward, reducing contact pressure from the screw acting on the conductive bridge component. This reduces connection confidence and can cause functionality problems for the conductive isolator. Radial stiffness is also unintentionally increased due to the added contact surface area.

To address this issue, each conductive bridge component 16 includes two concentrically lined axial contact points 20. The axial contact points 20 are designed to complete the electrical connection with the insert plate 22 captured within the groove. The axial contact points 20 are lined up directly to allow contact on both the top and bottom surface of the groove captured component. This is to ensure any mounting orientation of the conductive isolator 10 to the assembly 14 and to allow a better grip once the screw 24 is installed.

As the top and bottom halves of the damping structure 12 compress down from the screw 24, a small portion of the force transfers through to the top and bottom of the conductive bridge component 16, causing the conductive bridge component 16 to grip onto the insert plate 22 for an ensured contact point on both top and bottom surfaces. This behavior is built in to compensate for tolerances between the groove thickness on the conductive isolator 10 and actual insert plate 22 thickness in the assembly 14.

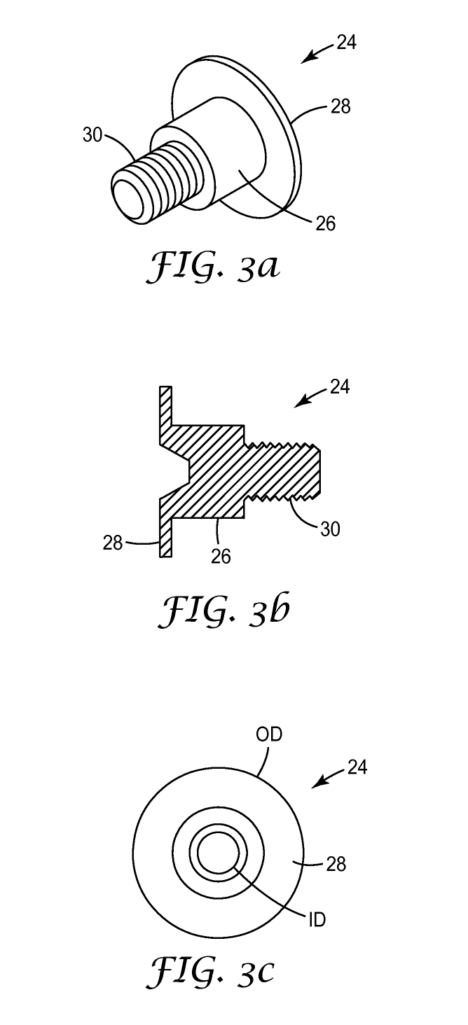

FIGS. 3a, 3b and 3c show a perspective view, a cross-sectional view and a top view, respectively, of the screw 24. Although the remainder of the specification will refer to a screw, one of skill in the art will realize that a post, dowel or pin may be used without departing from the intended scope of the present invention. In one embodiment, the screw 24 is a shoulder screw including a main body 26, a head 28 and a threaded portion 30. The screw 24 may be made of any suitable conductive material, including, but not limited to: metal and plastic such as stainless steel, low carbon steel, SECC, ABS, PC/ABS or PC. In one embodiment, the screw 24 is between about 8.2 and about 8.4 mm long with the main body 26 being between about 3.7 mm and about 3.9 mm long, the head 28 being between about 0.4 mm and about 0.6 mm long and the threaded portion 30 being between about 3.9 mm and about 4.1 mm long. In one embodiment, the screw 24 has an outer diameter (OD) of between about 8.9 mm and about 9.1 mm and an inner diameter (ID) of between about 4.7 mm and about 4.9 mm.

Generally, the core function of an isolator is to ensure that the screw does not touch the assembly captured within. Any short circuit in the assembly may introduce a transmission path so that, for example, a grommet that can both fully isolate and be electrically conductive, cannot be achieved with a non-conductive damping structure. The only way to achieve electrical conductivity using a non-conductive damping structure is to introduce a conductive bridge component.

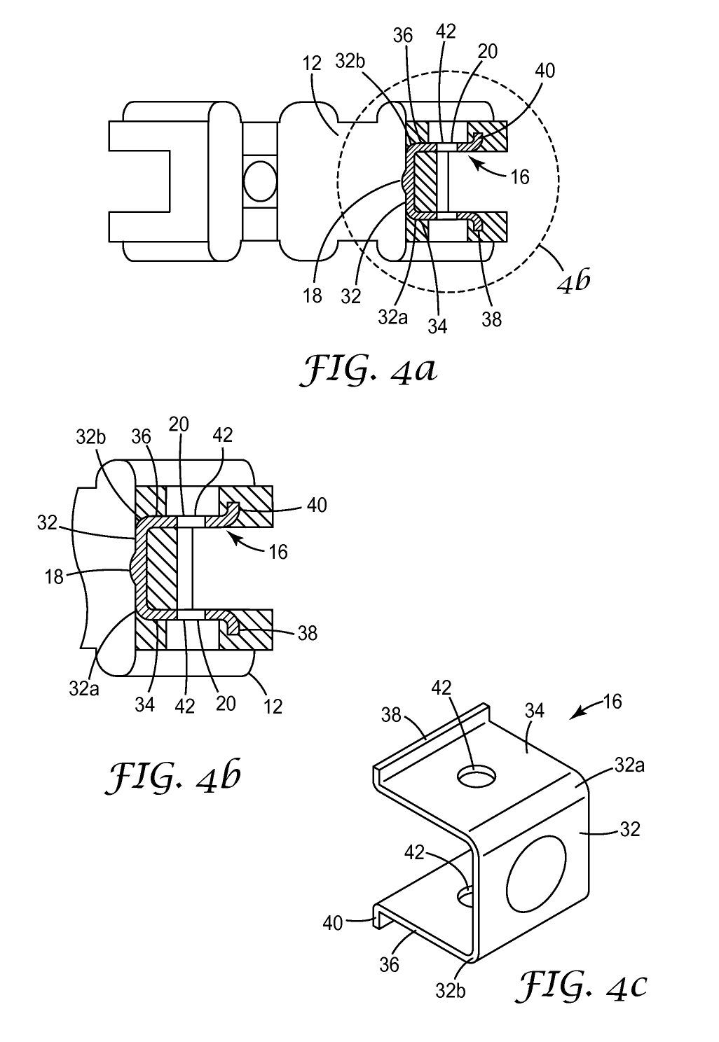

FIG. 4a shows a cross-sectional view of the conductive isolator 10 through line A-A shown in FIG. 1b. FIG. 4b shows an enlarged cross-sectional view surrounding the conductive bridge component 16 and FIG. 4c shows a perspective view of the conductive bridge component 16. The conductive bridge component 16 causes the damping structure 10 to lose its isolation function. However, functional performance can be retained through innovative design and use of a thin, soft conductive material. The conductive bridge component 16 may be formed of any material suitable for forming an electrical connection. For example, the conductive bridge component 16 may be formed of thin aluminum or any metallic material with good electrical conductivity properties. As can be seen from FIGS. 4a-4c, the conductive bridge component 16 is in the shape of a “U” and includes a first section 32 having a first end 32a and a second end 32b, a second section 34 attached to the first end 32a and a third section 36 attached to the second end 32b. In some embodiments, each of the second and third sections 34, 36 also includes a flange 38, 40, respectively, extending away from the “U” shape formed by the conductive bridge component 16. Each of the first, second and third sections 32, 34, 36 of the conductive bridge component 16 may include a through hole 42. In one embodiment, the first section 32 is between about 1.8 mm and about 2.0 mm long and the second and third sections 34, 36 are between about 1.6 mm and about 1.8 mm long. In one embodiment, the first, second and third sections 32, 34, 36 are about 1.9 mm to about 2.1 mm wide, with the second and third sections 34, 36 spaced between about 1.4 and about 1.6 mm apart from each other. In one embodiment when the conductive bridge component 16 includes flanges, the flanges 38, 40 extend between about 0.25 mm and about 0.35 mm away from the second and third sections 34, 36, respectively.

The conductive bridge component 16 provides the contact necessary to facilitate an electrical connection within the isolator 10. Using the conductive isolator 10, an electrical connection is completed at a groove in the assembly 14 where the conductive isolator 10 is captured and at the inner diameter, where the corresponding screw 24 is installed. The presence of the conductive bridge component 16 increases overall stiffness and allows a direct transmission path for vibration to travel in and out of the system. The conductive isolator 10 thus allows retention of functional damping performance while also being electrically conductive.

Although the conductive bridge component 16 is the main feature which provides the conductivity, it is kept as thin as possible to limit stiffness. In one embodiment, the conductive bridge component 16 has a thickness of between about 0.1 mm and about 0.3 mm, with 0.2 mm being the nominal thickness.

In one embodiment, the conductive bridge component 16 is designed to wrap around the groove to allow axial ribbing to function as intended, adding to performance retention. In one embodiment, the conductive isolator 10 includes at least three conductive bridge components 16 positioned about 120° apart from one another to ensure contact regardless of the installed orientation of the conductive isolator 10. Because it is symmetrical on all surfaces, the conductive isolator 10 can be picked up and installed regardless of which direction the conductive isolator 10 is facing. In addition, the U-shape design of the conductive bridge component 16 is used specifically to enhance contact. As the screw 24 is tightened, the axial pre-compression grips the metal component inside the groove. This also causes the radial contact point 18 to be pushed inward slightly toward the screw 24, adding to the radial contact.

The conductive bridge component 16 is positioned within the damping structure 12, which in one embodiment is made of an elastomer material. The damping structure 12 provides energy dissipation from a shock or vibration input, reducing the effects of high level acceleration that could be destructive to, for example, a hard disk drive. The damping structure 12 can be in the shape of a ring and addresses the increased stiffness side effect from the enhanced contact, reducing the radial stiffness artificially increased from the addition of the conductive bridge component 16. The damping structure 12 may be formed from any suitable highly damped and moldable elastomeric material. Examples of suitable elastomeric materials include, but are not limited to, polyurethane (PU), polyethylene terephthalate (PET) and silicone. The damping structure may be made by any suitable method, such as injection molding or compression molding. In one embodiment, the damping structure has an outer diameter of between about 9.9 mm and about 10.1 mm and an inner diameter of between about 4.9 mm and about 5.1 mm.

Referring back to FIG. 2, the damping structure 12 acts as a cushion between the insert plate 22 and the conductive bridge component 16 and screw 24. During vertical mount situations where the weight of the assembly is acting on the conductive isolator 10 in the radial direction, the damping structure 12 compresses, giving some much needed sway space in the radial direction, reducing radial stiffness. Through holes 42 in the damping structure 12 and conductive bridge component 16 design allow space for the deflection to occur and also helps with manufacturability.

Alternatively, grooves can be designed into the damping structure 12 if additional stiffness reduction is required.

### EXAMPLES

The present invention is more particularly described in the following examples that are intended as illustrations only, since numerous modifications and variations within the scope of the present invention will be apparent to those skilled in the art. Unless otherwise noted, all parts, percentages, and ratios reported in the following example are on a weight basis.

### Performance Calculations

Prophetic calculations were carried out comparing the stiffness change in a conductive isolator compared to a non-conductive isolator. The goal of the calculations was to check if the conductive isolator was designed to be as close to the non-conductive isolator as possible in terms of stiffness in both axial and radial orientations. By matching stiffness, performance of the isolator is retained.

In making the calculations, it was assumed that: the weight acting on the isolators in the axial and radial directions was exactly 0.1 kg; the contact area of the non-conductive isolator in the radial direction was about 33% of inner diameter surface; and that all dimensions were nominal with no maximum or minimum tolerances factored into the dimensions used for the stiffness calculations. Thus, actual values may vary. The material evaluated was C-8002 with properties taken at 120 hz and 30° C. (nominal hard disk drive operating condition). C-8002 is a thermoplastic elastomer (TPE) solid thermoplastic isolator available from E-A-R, Aearo Technologies, Indianapolis, Ind.

The load area value is the primary contact area between the isolator (rib surface) and the screw/assembly. The rib was assumed to be rectangular in shape with the area calculated as the length times the width.

The bulge area value was the expected area where the damping structure would deflect/bulge when the load was applied. It was assumed to be the sides of the rib geometry.

The shape factor value was the load area divided by the bulge area. It can be used to check rib rigidity and is also required for the Ecorrected value in later calculations.

The Youngs Modulus (E) value was derived from the material nomogram for C-8002 at 120 hz and 30° C.

The loss factor value was derived from the material nomogram for C-8002 at 120 hz and 30° C.

The corrected Youngs Modulus (Ecorrected) value factored in geometry, allowing a more accurate calculation of the modulus of the material. The shape factor was plugged into Equation (I) to update the E value with respect to the geometry.

Ecorrected=(4/3)*(E)*(1+Ŝ2), Equation (I):

where E is the Youngs Modulus and S is the shape factor.

The stiffness was calculated using the corrected Youngs Modulus (Ecorrected) and the dimensions of the damping structure in contact (under loading, usually the rib). The approximate stiffness of the part in either axial or radial loading conditions was calculated using Equation (II).

Stiffness(k)=(Ecorrected)*(length of contact damping structure)*(width of contact damping structure)/(thickness of contact damping structure) Equation (II):

If there are a series of contact damping structures, such as when several ribs are in contact, the stiffness was added together for a total.

The natural frequency was calculated once stiffness was known using Equation (III).

Fn=0.16*sqrt(k/weight), Equation (III):

where the weight is assumed to be roughly 0.1 kg, a common weight for 2.5 inch HDDs.

The properties and axial calculations of the non-conductive and conductive isolators are shown below in Table 1.

TABLE 1
Axial Calculations

| | Non-conductive | Conductive |
|---|---|---|
| Property | Isolator | Isolator |
| Rib width (mm) | 1.50 | 1.50 |
| Rib length (mm) | 2.50 | 2.50 |
| Rib height (mm) | 0.50 | 0.50 |
| Total height (mm) | 1.25 | 1.25 |
| Number of ribs | 6.00 | 6.00 |
| Load area (mm²) | 3.75 | 3.75 |
| Bulge area (mm²) | 4.00 | 4.00 |
| Shape factor | 0.94 | 0.94 |
| EC-8002 @ 120 hz, 30° C. | 12.00 | 12.00 |
| nC-8002 @ 120 hz, 30° C. | 0.80 | 0.80 |
| Ecorrected (N/mm²) | 30.6 | 30.6 |
| Stiffness, K (N/mm) | 541.13 | 541.13 |
| Natural Frequency, fn (hz) | 372.19 | 372.19 |

As can be seen by the data in Table 1, the axial calculations show the exact same properties for the non-conductive isolator and the conductive isolator. The isolators were set in between the ribbing so that during compression, the axial stiffness change is negligible as the area underneath each rib remains identical.

The properties and radial calculations of the non-conductive isolator and conductive isolator are shown below in Table 2.

TABLE 2
Radial Calculations

| | Non-conductive | | Conductive |
|---|---|---|---|
| Property | Isolator | Property | Isolator |
| Groove Outer Radius | 3.50 | Rib width (mm) | 2.00 |
| (mm) | | | |
| Inner Radius (mm) | 2.50 | Rib length (mm) | 2.00 |
| Percentage of contact | 0.33 | Total height (mm) | 0.80 |
| (mm) | | | |
| Total contact length | 4.00 | Number of ribs | 3.00 |
| (mm) | | | |
| Load area (mm²) | 20.73 | Load area (mm²) | 4.00 |
| Bulge area (mm²) | 10.37 | Bulge area (mm²) | 1.57 |
| Shape factor | 2.00 | Shape factor | 2.55 |
| EC-8002 @ 120 hz, 30° C. | 12.00 | EC-8002 @ 120 hz, 30° C. | 12.00 |
| nC-8002 @ 120 hz, 30° C. | 0.80 | nC-8002 @ 120 hz, 30° C. | 0.80 |
| Ecorrected (N/mm²) | 80.00 | Ecorrected (N/mm²) | 119.75 |
| Stiffness, K (N/mm) | 1658.76 | Stiffness, K (N/mm) | 1796.29 |
| Natural Frequency, | 651.65 | Natural Frequency, | 678.12 |
| fn (hz) | | fn (hz) | |

As can be seen by the data in Table 2, the radial calculations show that the addition of the isolators adds slightly over approximately 8% to the stiffness. However, this does not factor in additional force acting on the radial sections from the isolators due to tolerance differences from the nominal condition.

Although the present invention has been described with reference to preferred embodiments, workers skilled in the art will recognize that changes may be made in form and detail without departing from the spirit and scope of the invention.

1. A conductive isolator comprising:
a damping structure;
a conductive bridge component positioned within the damping structure;
axial contact points between the damping structure and the conductive bridge component; and
radial contact points between the damping structure and the conductive bridge component.

2. The conductive isolator of claim 1, wherein the conductive isolator comprises at least three conductive bridge components.

3. The conductive isolator of claim 2, wherein the conductive bridge components are positioned about 120° apart from each other.

4. The conductive isolator of claim 2, wherein the conductive bridge components form a U-shape.

5. The conductive isolator of claim 1, wherein the radial contact points protrude from flush side walls of an assembly.

6. The conductive isolator of claim 1, comprising two concentrically lined axial contact points for each conductive bridge component.

7. The conductive isolator of claim 1, wherein the damping structure is in the shape of a ring.

8. The conductive isolator of claim 1, wherein the damping structure is formed of an elastomeric material.

9. An apparatus comprising:
a conductive isolator comprising:
a damping structure;
a conductive bridge component positioned within the damping structure;
radial contact points between the damping structure and the conductive bridge component; and
axial contact points between the damping structure and the conductive bridge component; and
an assembly housing the conductive isolator, the assembly comprising:
an insert plate; and
a screw adapted to engage a through hole in the insert plate.

10. The apparatus of claim 9, wherein the conductive isolator comprises at least three conductive bridge components.

11. The apparatus of claim 9, wherein the radial contact points protrude from flush side walls of an assembly.

12. The apparatus of claim 9, wherein the damping structure is in the shape of a ring.

13. The apparatus of claim 9, wherein the damping structure is formed of an elastomeric material.

14. A method of providing electrical connection through an isolator comprising:
providing an isolator, wherein the isolator comprises a conductive bridge component housed within a non-conductive damping structure; and
facilitating radial and axial contact points between the conductive bridge component and non-conductive damping structure.

15. The method of claim 14, further comprising positioning the isolator within an assembly.

16. The method of claim 15, further comprising facilitating a radial contact point between the conductive bridge component and the assembly.

17. The method of claim 16, further comprising facilitating the radial contact point between the conductive bridge component and a screw of the assembly.
